(19) United States
(12) Patent Application Publication
(10) Pub. No.: US 2026/0131431 A1
(43) Pub. Date: May 14, 2026

(54) Driving Tool with Insulated Shaft

(71) Applicant: Milwaukee Electric Tool Corporation, Brookfield, WI (US)

(72) Inventor: Marko Todorovic, Oak Creek, WI (US)

(21) Appl. No.: 19/348,092

(22) Filed: Oct. 2, 2025

Related U.S. Application Data
(60) Provisional application No. 63/717,974, filed on Nov. 8, 2024.
(60) Provisional application No. 63/737,082, filed on Dec. 20, 2024.

(51) Int. Cl. B25B 15/00; B25B 23/00; H01B 17/62

(52) U.S. Cl. CPC B25B 15/002; B25B 15/005; B25B 15/007; B25B 23/0042; H01B 17/62

(57) ABSTRACT

Various embodiments of a driving tool providing electrical with an insulated shaft are provided. In various embodiments, the shaft includes shanks that are separated, such as by a joint, to reduce the electrical connectivity between the shanks and thus between ends of the shaft. In various embodiments, the shaft is covered by one or more coatings of electrically resistant material.

### CROSS-REFERENCE TO RELATED PATENT APPLICATIONS

This application claims the benefit of and priority to U.S. Provisional Application No. 63/737,082, filed on Dec. 20, 2024, and U.S. Provisional Application No. 63/717,974, filed on Nov. 8, 2024, each of which is incorporated herein by reference in its entirety.

### BACKGROUND OF THE INVENTION

The present invention relates generally to the field of hand tools. The present invention relates specifically to a driving tool with an insulated and/or reversible shaft.

### SUMMARY OF THE INVENTION

One embodiment of the invention relates to a driving tool including a handle and a shaft removably coupled to the handle. The shaft extends along a first longitudinal axis and includes a first shank, a second shank, a joint, a first operative end extending from the first shank, and a second operative end extending from the second shank. The joint separates the first shank and the second shank. At least a portion of the first shank is inserted in the handle when the second operative end is furthest from the handle and at least a portion of the second shank is inserted in the handle when the first operative end is furthest from the handle. The joint is formed from an electrically insulating material and the joint is positioned between the first shank and the second shank to provide electrical insulation between the first shank and the second shank.

Another embodiment of the invention relates to a driving tool including a handle and a shaft removably coupled to the handle. The shaft extends along a first longitudinal axis and includes a first shank coupled to a second shank such that torque applied to a first end of the shaft is transmitted to a second end of the shaft opposite the first end with respect to the first longitudinal axis. The first shank is formed from a first piece of metal material, and the second shank is formed from a second piece of metal material distinct and separate from the first piece of metal material. The first shank is spaced apart from the second shank along the first longitudinal axis such that the first shank does not touch the second shank.

Another embodiment of the invention relates to a driving tool including a handle and a shaft removably coupled to the handle. The shaft extends along a first longitudinal axis and includes a first shank, a second shank, a joint, a first operative end extending from the first shank, a second operative end extending from the second shank, and a first coating circumferentially surrounding the first shank and a second coating circumferentially surrounding the second shank. The first coating and second coating are formed from an electrically insulating material. The joint separates the first shank and the second shank. At least a portion of the first shank is inserted in the handle when the second operative end is furthest from the handle and positioned to be used, and at least a portion of the second shank is inserted in the handle when the first operative end is furthest from the handle and positioned to be used.

Another embodiment of the invention relates to a driving tool including a handle and a shaft removably coupled to the handle. The shaft extends along a longitudinal axis and includes a first portion, a second portion, and a joint. The first portion of the shaft is centered on the longitudinal axis. The second portion of the shaft is centered on the longitudinal axis and is spaced a distance from the first portion along the longitudinal axis. The joint is positioned between the first portion and the second portion, and the joint is made of a non-electrically conductive material.

Another embodiment of the invention relates to a driving tool including a handle and a shaft removably coupled to the handle. The shaft extends along a longitudinal axis and includes a first portion coupled to a second portion such that torque applied to a first end of the shaft is transmitted to a second end of the shaft opposite the first end. The first portion of the shaft is formed from a first piece of metal material, and the second portion of the shaft is formed from a second piece of metal material distinct and separate from the first piece of metal material. The first portion of the shaft is spaced apart from the second portion of the shaft along the longitudinal axis such that the shafts are physically separated, and the first portion of the shaft does not touch the second portion of the shaft. In this way, there is no electrically conductive path defined between the first portion of the shaft and the second portion of the shaft. In a specific embodiment, a joint couples the first portion of the shaft to the second portion of the shaft. The joint is formed from a non-metallic material having an electrical conductivity less than an electrical conductivity of the metal material of the first and second portions of the shaft.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side cross-sectional view of a driving tool, according to an exemplary embodiment;

FIG. 2 is a side view of the shaft of the driving tool of FIG. 1, according to an exemplary embodiment;

FIG. 3 is a side cross-sectional view of the shaft of the driving tool of FIG. 1, according to an exemplary embodiment;

FIG. 4 is a side cross-sectional view of a driving tool, according to an exemplary embodiment;

FIG. 5 is a side cross-sectional view of the shaft of the driving tool of FIG. 4, according to an exemplary embodiment;

FIG. 6 is a side cross-sectional view of a driving tool, according to an exemplary embodiment;

FIG. 7 is a side cross-sectional view of the shaft of the driving tool of FIG. 6, according to an exemplary embodiment;

FIG. 8 is a side cross-sectional view of a driving tool, according to an exemplary embodiment;

FIG. 9 is a side cross-sectional view of the shaft of the driving tool of FIG. 8, according to an exemplary embodiment;

FIG. 10 is a side cross-sectional view of a driving tool, according to an exemplary embodiment;

FIG. 11 is a side cross-sectional view of a driving tool, according to an exemplary embodiment;

FIG. 12 is a detailed cross-sectional view of the joint of the driving tool of FIG. 11, according to an exemplary embodiment;

FIG. 13 is a detailed cross-sectional view of a joint of a shaft for a driving tool, according to an exemplary embodiment;

FIG. 14 is a side cross-sectional view of a driving tool, according to an exemplary embodiment;

FIG. 15 is a side cross-sectional view of the shaft of the driving tool of FIG. 14, according to an exemplary embodiment; and

FIG. 16 is a side cross-sectional view of a shaft for a driving tool, according to an exemplary embodiment.

### DETAILED DESCRIPTION

Referring generally to the figures, various embodiments of a driving tool, such as a screwdriver, nut driver, etc., with an insulated shaft are shown. Applicant believes that the driving tools discussed herein provide for various advantages over typical insulated driving tools. Specifically, the driving tools discussed herein include a shaft with a first portion and a second portion connected by a joint. The joint is formed from a non-electrically conductive material. In this way, the shaft does not provide an electrically conductive path between the first portion and the second portion. Additionally, in various embodiments, the shaft includes an outer coating of a non-electrically conductive material, which further decreases electrical conductivity along the shaft.

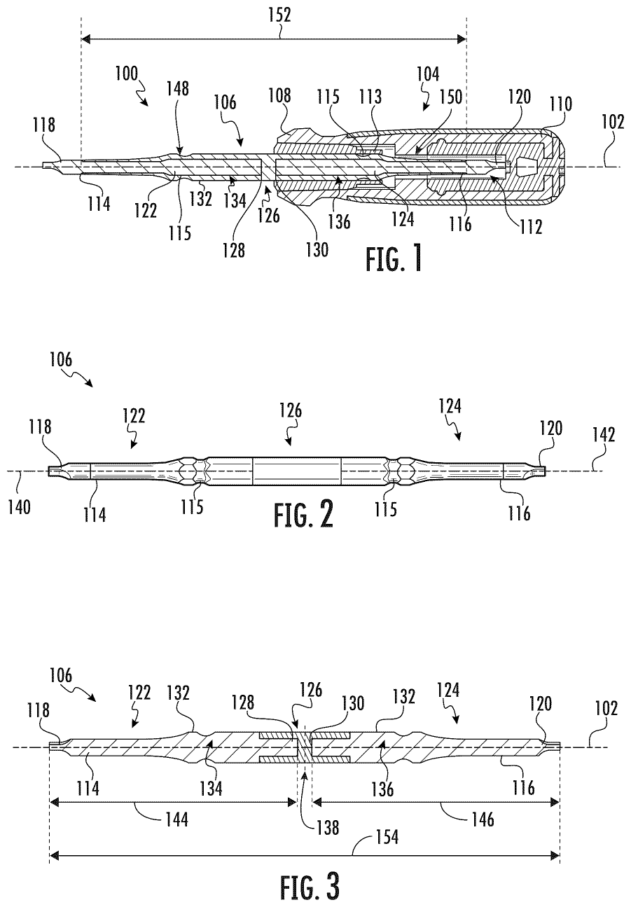

Referring to FIGS. 1-3, a driving tool, such as screwdriver 100, is shown and described. Screwdriver 100 is centered on and extends along a first longitudinal axis 102. Screwdriver 100 includes a handle 104 and a shaft 106 removably coupled to handle 104. Shaft 106 is coupled to handle 104 and is configured to engage an engagement bit, such as a screwdriver bit.

Handle 104 has a mounting end 108 and a second end 110 opposite mounting end 108 along first longitudinal axis 102. Shaft 106 is configured to be removably coupled to handle 104. Specifically, shaft 106 is received and retained within a channel 112 formed in handle 104. When coupled to handle 104, shaft 106 is centered on and extends along the first longitudinal axis 102. In particular, shaft 106 extends out of channel 112 in a direction away from mounting end 108 and second end 110 along longitudinal axis 102.

Handle 104 includes a retention mechanism 113 configured to receive and retain shaft 106 within channel 112. Shaft 106 includes retention features 115, such as grooves and/or protrusions, configured to engage with retention mechanism 113 to retain shaft 106 in handle 104 when screwdriver 100 is in use.

Shaft 106 has a first end 114 and a second end 116 opposite first end 114 along first longitudinal axis 102. Shaft 106 extends along a first longitudinal axis 102 and includes a first shank 122 coupled to a second shank 124 such that torque applied to a first end 114 of the shaft 106 is transmitted to a second end 116 of the shaft 106 opposite the first end 114 with respect to the first longitudinal axis 102. As shown, shaft 106 is a reversible shaft with a first operative end 118 located at first end 114 and a second operative end 120 located at second end 116. In various embodiments, first operative end 118 is a Phillips head and second operative end 120 is a flat head. In such embodiments, first operative end 118 is in the shape of a cross and second operative end 120 is linear shaped. In various embodiments, the first operative end 118 includes a Phillips head. In various embodiments, the second operative end 120 includes a flat head configured to drive screws.

Shaft 106 includes a first portion or first shank 122, a second portion or second shank 124, and a joint 126 positioned between first shank 122 and second shank 124. In various embodiments, the joint 126 is located at a midpoint 138 of the shaft along the first longitudinal axis. Shaft 106 extends along first longitudinal axis 102 and includes a first shank 122, a second shank 124, a joint 126, a first operative end 118 extending from the first shank 122, and a second operative end 120 extending from the second shank 124, the joint 126 separating the first shank 122 and the second shank 124. In various embodiments, first shank 122 is centered on first longitudinal axis 102 and second shank 124 is centered on and aligned with first shank 122 along first longitudinal axis 102. First shank 122 includes the first end 114 of shaft 106 and includes a first end 128 opposite the first end 114. Stated another way, first shank 122 extends from a first end 128 to the first operative end 118 opposite the first end 128. In various embodiments, the joint 126 circumferentially surrounds the first end 128. Second shank 124 includes second end 116 of shaft 106, and second shank 124 includes a second end 130 opposite the second end 116. Stated another way, the second shank 124 extends from a second end 130 to the second operative end 120 opposite the second end 130. In various embodiments, the joint 126 circumferentially surrounds the second end 130. First end 128 and second end 130 are spaced from each other along first longitudinal axis 102. First shank 122 and second shank 124 are made of an electrically conductive material, such as a metal. In various embodiments, first shank 122 is non-integrally formed with second shank 124.

In various embodiments, the first shank 122 extends along a second longitudinal axis 140 that is colinear with the first longitudinal axis 102, and the second shank 124 extends along a third longitudinal axis 142 that is colinear with the first longitudinal axis 102. In various embodiments, the first shank 12 defines a first length 144 and the second shank 124 defines a second length 146 that is within 5% of the first length 144.

In various embodiments, at least a portion of the first shank 122 is inserted in the handle 104 when the second operative end 120 is furthest from the handle 104, and at least a portion of the second shank 124 is inserted in the handle 104 when the first operative end 118 is furthest from the handle 104. Joint 126 is located between first end 128 of first shank 122 and second end 130 of second shank 124. Joint 126 surrounds first end 128 and second end 130. Specifically, first end 128 is coupled to joint 126 and second end 130 is coupled to joint 126 such that first shank 122 and second shank 124 are coupled together via joint 126. Joint 126 is made from a non-electrically conductive material, such as insulated injection mold material, fiber glass, ceramic, insulated plastic material, etc. In various embodiments, the joint 126 is formed from an electrically insulating material and the joint 126 is positioned between the first shank 122 and the second shank 124 to provide electrical insulation between the first shank 122 and the second shank 124. In this way, shaft 106 does not provide an electrically conductive path between first shank 122 and second shank 124. In various embodiments, joint 126 is designed to provide strength/resistance when bending and twisting loads are applied to shaft 106.

Specifically, joint 126 is made from a first material that has an electrical conductivity, and first shank 122 and second shank 124 are made from a second material that has an electrical conductivity greater than the electrical conductivity of the first material. In a specific embodiment, the electrical conductivity of the first material of joint 126 is less than 1% of the electrical conductivity of the second material of the shanks 122 and 124. In various embodiments, the first shank 122 is formed from a first metal material. In various embodiments, the joint 126 is formed from a first material, and the first material is less than 1% of the electrical conductivity of the first metal material. In various embodiments, the second shank 124 is formed from a second metal material. In various embodiments, the first metal material is the same as the second metal material. Stated another way, in various embodiments the first shank 122 is formed from a first metal material, and the second shank 124 is formed from the first metal material. In various embodiments, the joint is formed from a first material, and the first material is less than 10% of the electrical conductivity of the first metal material, and more specifically less than 5% of the electrical conductivity of the first metal material, and even more specifically less than 1% of the electrical conductivity of the first metal material. In various embodiments, the first shank 122 is formed from a first piece of metal material, and the second shank 124 is formed from a second piece of metal material distinct and separate from the first piece of metal material. In various embodiments, the first shank 122 is spaced apart from the second shank 124 along the first longitudinal axis 102 such that the first shank 122 does not touch the second shank 124.

As shown, joint 126 is located at the midpoint of shaft 106. Specifically, first shank 122 and second shank 124 are substantially the same length and joint 126 is evenly positioned between first shank 122 and second shank 124. In various embodiments, joint 126 is biased towards one end of shaft 106. The location of retention features 115 may vary along the length of shaft 106 based on the location of joint 126.

In a specific embodiment, the location of joint 126 is biased towards first operative end 118 of shaft 106. In such an embodiment, first shank 122 has a shorter length than second shank 124. Applicant believes that by biasing the location of joint 126 towards first operative end 118, shaft 106 provides greater support and leverage for second operative end 120, when second operative end 120 is extending away from mounting end 108 of handle 104 and engaging a workpiece. In a specific embodiment, first operative end 118 is a Phillips head, and second operative end 120 is a flat head.

Shaft 106 further includes an shaft coating 132. Shaft coating 132 is made of a non-electrically conductive material. Shaft coating 132 is applied to an outer surface 134 of first shank 122 and outer surface 136 of second shank 124. Shaft coating 132 does not cover operative ends 118, 120. In various embodiments, joint 126 may be made from a different non-electrically conductive material from shaft coating 132. In other various embodiments, joint 126 may be made of a material that is translucent or a different color from shaft coating 132.

In various embodiments, shaft 106 includes a first coating 148 circumferentially surrounding the first shank 122 and a second coating 150 circumferentially surrounding the second shank 124, and the first coating 148 and second coating 150 are formed from an electrically insulating material. In various embodiments, the first coating 148 does not cover the first operative end 118. In various embodiments, the shaft 106 includes a shaft coating 132 that includes the first coating 148 and the second coating 150, and the first coating 148 is integrally molded with the second coating 150. In various embodiments, the shaft coating 132 defines a coating length 152, and the shaft 106 defines a shaft length 154, and the coating length 152 is at least 50% of the shaft length 154, and more specifically at least 80%.

In various embodiments, shaft 106 is assembled in a single molding step such that joint 126, shaft coating 132 on first shank 122, and outer coating on second shank 124 are made from a single shot of non-electrically conductive injection mold material. In other various embodiments, shaft 106 may be assembled with more than one molding step. In a specific embodiment, three separate shots of non-electrically conductive injection mold material are used. In such an embodiment, a first shot is used to apply shaft coating 132 to first shank 122, a second shot is used to apply shaft coating 132 to second shank 124, and a third shot is used to couple first shank 122 and second shank 124 together and to define joint 126.

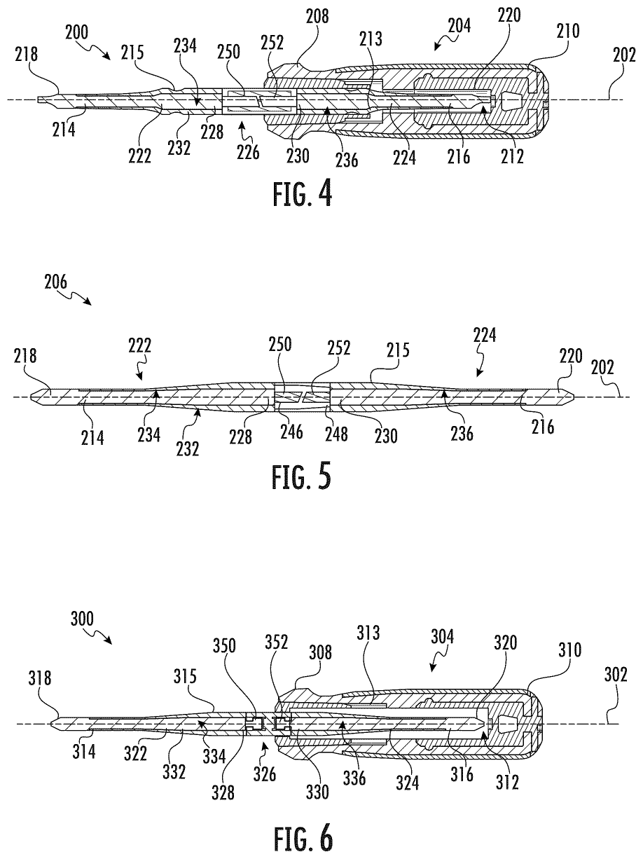

Referring to FIGS. 4-5, a driving tool with an insulated shaft, such as a screwdriver 200, is shown according to an exemplary embodiment. Screwdriver 200 is substantially the same as screwdriver 100 except for the differences discussed herein. Specifically, screwdriver 200 includes a first shank 222 and a second shank 224. Shanks 222, 224 each include a rectangular-shaped projection and a joint 226 is formed between and around the projections.

Screwdriver 200 includes a handle 204 and a shaft 206 mounted in handle 204. Shaft 206 includes first shank 222 and second shank 224. Third end 228 of first shank 222 includes an end surface 246 and a first projection 250 extending away from end surface 246. Fourth end 230 of second shank 224 includes an end surface 248 and a second projection 252 extending away from end surface 248. End surface 248 faces towards end surface 246 such that first projection 250 and second projection 252 extend towards each other. First projection 250 and second projection 252 are spaced apart from each other such that they are not directly interfacing with each other. Joint 226 is formed around and between projections 250, 252 to couple first shank 222 and second shank 224 together.

Projections 250, 252 each include a non-electrically conductive coating 254 along an outer surface of the projections 250, 252. Coating 254 further insulates shaft 206 to decrease electrical conductivity between first shank 222 and second shank 224. As shown, first projection 250 and second projection 252 are rectangular-shaped and have different widths.

Shaft 206 is assembled in a single molding step such that outer coating 232 and joint 226 are made from a single shot of non-electrically conductive injection mold material. When assembled, the injection mold material surrounds projections 250, 252 and fills the space between the projections 250, 252 to define joint 226.

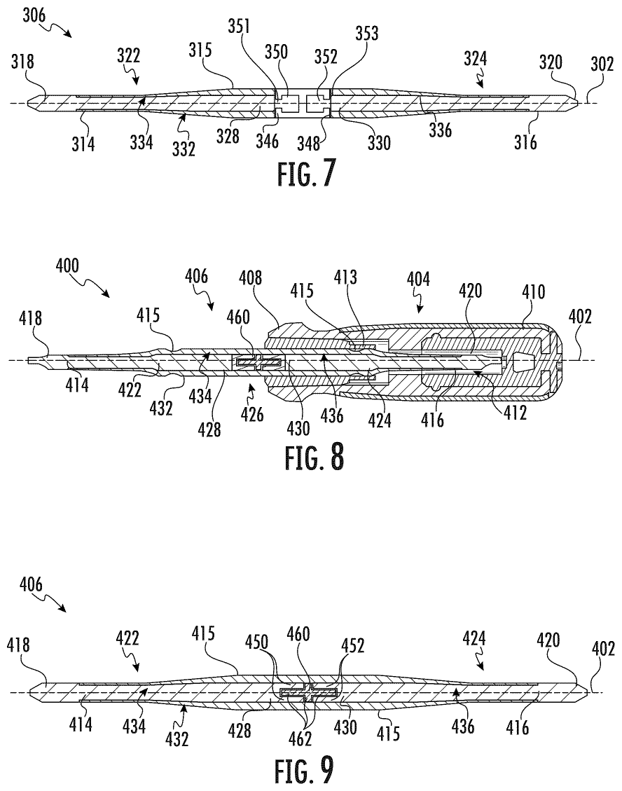

Referring to FIGS. 6-7, a driving tool with an insulated shaft, such as a screwdriver 300, is shown according to an exemplary embodiment. Screwdriver 300 is substantially the same as screwdrivers 100 and 200, except for the differences discussed herein. Specifically, screwdriver 300 includes T-shaped projections. Applicant believes that T-shaped projections may provide additional resistance to tensile, bending, and torsion loads.

Screwdriver 300 includes a handle 304 and a shaft 306 mounted in handle 304. Shaft 306 includes a first shank 322 and a second shank 324. Third end 328 of first shank 322 includes an end surface 346 and a first T-shaped projection 350 extending away from end surface 346. First T-shaped projection 350 defines a first neck 351. Fourth end 330 of second shank 324 includes an end surface 348 and a second projection 352 extending away from end surface 348. Second T-shaped projection 352 defines a second neck 353. Joint 326 is formed around and between projections 350, 352 to couple first shank 322 and second shank 324 together.

In various embodiments, shaft 306 is assembled in a single molding step such that outer coating 332 and joint 326 are made from a single shot of non-electrically conductive injection mold material. When assembled, the injection mold material surrounds projections 350, 352. The injection mold material also surrounds first neck 351 and second neck 353. Joint 326 defines a first lip 355 secured between T-shaped projection 350 and end 328, and a second lip 356 secured between T-shaped projection 352 and end 330.

In a specific embodiment, three separate shots of non-electrically conductive injection mold material are used. In such an embodiment, a first shot is used to apply outer coating 332 to first shank 322, a second shot is used to apply outer coating 332 to second shank 324, and a third shot is used to couple first shank 322 and second shank 324 together and to define joint 326.

Referring to FIGS. 8-9, a driving tool with an insulated shaft, such as a screwdriver 400, is shown according to an exemplary embodiment. Screwdriver 400 is substantially the same as screwdrivers 100, 200, and 300, except for the differences discussed herein. Specifically, screwdriver 400 includes a cross-shaped spacer between a first shank 422 and a second shank 424.

Screwdriver 400 includes a handle 404 and a shaft 406 mounted in handle 404. Shaft 406 includes first shank 422 and second shank 424. Third end 428 of first shank 422 includes two first projections 450 extending away from end 428. Fourth end 430 of second shank 424 includes two second projections 452 extending away from end 430 towards first projections 450. A spacer 460 is positioned between third end 428 and fourth end 430. Spacer 460 is made of a non-electrically conductive material, such as injection mold material, fiber glass, insulated plastic material, ceramic, etc.

As shown, spacer 460 is cross-shaped. Spacer 460 includes four arms 462 which are spaced substantially orthogonal to each other. As shown, one arm 462 is positioned between first projections 450 and one arm 462 is positioned between second projections 452. In this way, spacer 460 is configured to hold together and align first shank 422 and second shank 424. Arms 462 are also positioned between pairs of one first projection 450 and one second projection 452.

Joint 426 is formed around spacer 460 and projections 450, 452. Shaft 406 is assembled in a single molding step such that outer coating 432 and joint 426 are made from a single shot of non-electrically conductive injection mold material. When assembled, the injection mold material surrounds projections 450, 452 and spacer 460. The injection mold material then covers and fills the space between the projections 450, 452 and spacer 460 to define joint 426.

Referring to FIG. 10, a driving tool, such as screwdriver 500 is shown. Screwdriver 500 is substantially the same as screwdriver 400, except for the differences discussed herein. Specifically, screwdriver 500 has a joint 526 biased towards second tip 520.

Screwdriver 500 includes a handle 504 and a shaft 506 mounted in handle 504. Shaft 506 includes first shank 522 and second shank 524. As shown, first shank 522 includes a first tip 518 which is a flat head and second shank 534 includes second tip 520 which is a Phillips head. Joint 526 is positioned closer to second tip 520 along shaft 506. In this way, second shank 524 has a shorter length than first shank 522. Applicant believes that this configuration allows for the flat head tip to have a longer shank and have greater support when the flat tip is engaging a workpiece.

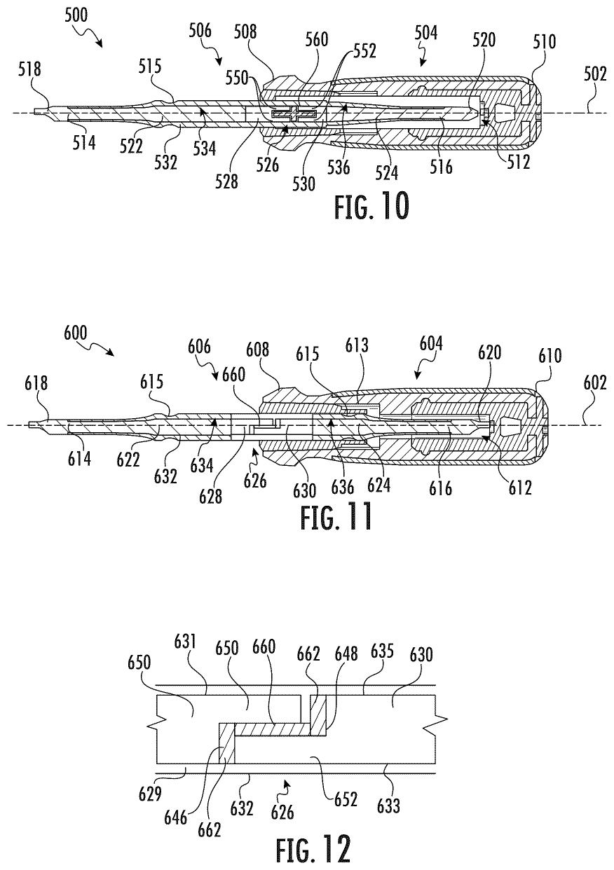

Referring to FIGS. 11-12, a driving tool with an insulated shaft, such as a screwdriver 600, is shown according to an exemplary embodiment. Screwdriver 600 is substantially the same as screwdrivers 100, 200, 300, 400, and 500, except for the differences discussed herein. Specifically, screwdriver 600 includes projections that extend parallel to each other and a spacer positioned between the projections. Applicant believes that this configuration may provide greater resistance to bending loads.

Screwdriver 600 includes a handle 604 and a shaft 606 mounted in handle 604. Shaft includes a first shank 622 and a second shank 624. Third end 628 of first shank 622 includes a first projection 650 extending away from end 628. Third end 628 includes an end surface 646, a first side surface 629, and a second side surface 631 opposite first side surface 629. First projection 650 is positioned along end surface 646 of first shank 622 such that first projection 650 is spaced away from second side surface 631. In a specific embodiment, projection 650 includes an outer surface 670 that is substantially level with first side surface 629.

Fourth end 630 of second shank 624 includes a second projection 652 extending away from end 630. Fourth end 630 includes an end surface 648, a first side surface 633, and a second side surface 635 opposite first side surface 633. Second projection 652 is positioned along end surface 648 of second shank 624 such that second projection 652 is spaced away from first side surface 633. In a specific embodiment, projection 652 includes an outer surface 672 that is substantially level with second side surface 635.

Projections 650, 652 are substantially parallel with each other and are spaced from each other in a direction orthogonal to longitudinal axis 602. Spacer 660 is positioned between first projection 650 and second projection 652. As shown, spacer 660 is z-shaped. Spacer 660 includes two tabs 662 which extend away from spacer 660 in opposite directions. One tab 662 is positioned between first projection 650 and fourth end 630, and one tab 662 is positioned between second projection 652 and third end 628.

Joint 626 is formed around spacer 660 and projections 650, 652. Shaft 606 is assembled in a single molding step such that outer coating 632 and joint 626 are made from a single shot of non-electrically conductive injection mold material. When assembled, the injection mold material surrounds projections 650, 652 and spacer 660 to define joint 626.

In a specific embodiment, screwdriver 600 does not include a spacer. In such an embodiment, when joint 626 is formed, the injection mold material surrounds projections 650, 652 and fills the space between projections 650, 652 to define joint 626.

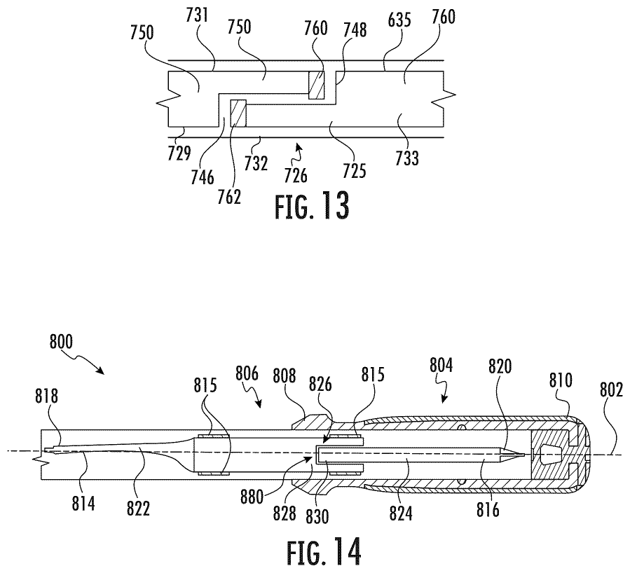

Referring to FIG. 13, a detailed view of a joint 726 of a shaft 706 for use with a driving tool, such as screwdrivers 100, 200, 300, 400, 500, and 600, is shown. Joint 726 and shaft 706 are substantially the same as joint 626 and shaft 606, except for the differences discussed herein. Specifically, shaft 706 includes two rectangular shaped spacers.

Shaft 706 includes a first shank 722 with a first projection 750 extending away from third end 728, and a second shank 724 with a second projection 752 extending away from fourth end 730. Projections 750, 752 are substantially parallel with each other and are spaced from each other in a direction orthogonal to longitudinal axis 702. A first spacer 760 is positioned between first projection 750 and fourth end 730. A second spacer 762 is positioned between second projection 752 and third end 728.

Joint 726 is formed around spacers 760, 762 and projections 750, 752. Shaft 706 is assembled in a single molding step such that outer coating 732 and joint 726 are made from a single shot of non-electrically conductive injection mold material. When assembled, the injection mold material surrounds projections 750, 752 and spacers 760, 762 to define joint 726.

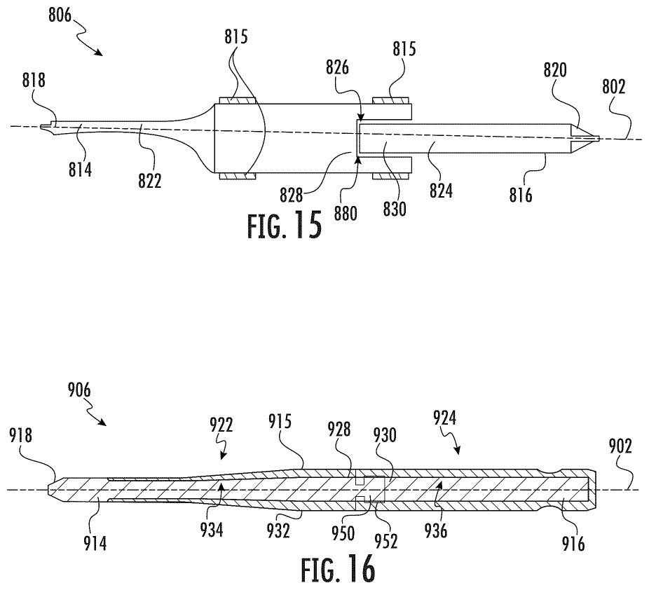

Referring to FIGS. 14-15, a driving tool with an insulated shaft, such as a screwdriver 800, is shown according to an exemplary embodiment. Screwdriver 800 is substantially the same as screwdrivers 100, 200, 300, 400, 500, and 600, except for the differences discussed herein. Specifically, screwdriver 800 includes a first shank 822 and a second shank 824. First shank 822 and second shank 824 are separately insulated and are mechanically joined together. Applicant believes that this configuration may provide greater resistance to torsion and bending loads.

Screwdriver 800 includes a handle 804 and a shaft 806. Shaft 806 is removably coupled to handle 804. Shaft 806 includes a first shank 822 and a second shank 824. As shown, first shank 822 includes a first tip 818 which is a flat head and second shank 824 includes a second tip 820 which is a Phillips head. First shank 822 includes a third end 826 with a channel 880 configured to receive and retain second shank 824. Specifically, a fourth end 830 of second shank 824 may be inserted into channel 880. In various embodiments, second shank 824 is mechanically joined to first shank 822.

Joint 828 is defined between third end 826 and fourth end 830. As shown, a non-electrically conductive coating is applied to an interior surface 881 of channel 880. In various embodiments, a separate non-electrically conductive coating may be applied to fourth end 830 of second shank 824 such that first shank 822 and second shank 824 are separately insulated.

As shown, joint 828 is positioned closer to second tip 820 along shaft 806. In this way, second shank 824 has a shorter length than first shank 822. Applicant believes that this configuration allows for the flat head tip to have a longer shank and have greater support when the flat head tip is engaging a workpiece.

Referring to FIG. 16, a shaft 906 for use with a handle, such as handle 104, 204, 304, 404, 504, 604, and 804, is shown according to an exemplary embodiment. Shaft 906 is substantially the same as shafts 106, 206, 306, 406, 506, 606, 706, and 806, except for the differences discussed herein. Specifically, shaft 906 is not a reversible shaft and does not include a second tip for engaging a workpiece.

Shaft 906 includes a first portion 922 and a second portion 924. First portion 922 includes a first end 914 of shaft 906 and a tip 918 configured to engage a workpiece. Second portion 924 includes a second end 916 of shaft 906. First portion 922 and second portion 924 are coupled together. A third end 928 of first portion 922 includes a projection 950 and fourth end 930 of second portion 924 includes a slot 952 configured to receive and retain projection 950. As shown, projection 950 is T-shaped and slot 952 is shaped to receive T-shaped projection 950.

Shaft 906 further includes an outer coating 932. Outer coating is made of a non-electrically conductive material. Outer coating 932 is applied to an outer surface 934 of first portion 922 and outer surface 936 of second portion 924.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A driving tool comprising:
a handle; and
a shaft removably coupled to the handle, the shaft extending along a first longitudinal axis and including a first shank, a second shank, a joint, a first operative end extending from the first shank, and a second operative end extending from the second shank, the joint separating the first shank and the second shank, wherein at least a portion of the first shank is inserted in the handle when the second operative end is furthest from the handle and at least a portion of the second shank is inserted in the handle when the first operative end is furthest from the handle, wherein the joint is formed from an electrically insulating material and the joint is positioned between the first shank and the second shank to provide electrical insulation between the first shank and the second shank.

2. The driving tool of claim 1, wherein the first shank is formed from a first metal material.

3. The driving tool of claim 2, wherein the joint is formed from a first material, and wherein the first material is less than 1% of the electrical conductivity of the first metal material.

4. The driving tool of claim 2, wherein the second shank is formed from a second metal material.

5. The driving tool of claim 4, wherein the first metal material is the same as the second metal material.

6. The driving tool of claim 2, wherein the joint is formed from a first material, and wherein the first material is less than 10% of the electrical conductivity of the first metal material.

7. The driving tool of claim 1, the first shank extending from a first end to the first operative end opposite the first end, wherein the joint circumferentially surrounds the first end.

8. The driving tool of claim 7, the second shank extending from a second end to the second operative end opposite the second end, wherein the joint circumferentially surrounds the second end.

9. The driving tool of claim 1, wherein the first operative end comprises a Phillips head.

10. The driving tool of claim 1, wherein the second operative end comprises a flat head configured to drive screws.

11. The driving tool of claim 1, wherein the joint is located at a midpoint of the shaft along the first longitudinal axis.

12. A driving tool comprising:
a handle; and
a shaft removably coupled to the handle, the shaft extending along a first longitudinal axis and comprising a first shank coupled to a second shank such that torque applied to a first end of the shaft is transmitted to a second end of the shaft opposite the first end with respect to the first longitudinal axis, wherein the first shank is formed from a first piece of metal material, and the second shank is formed from a second piece of metal material distinct and separate from the first piece of metal material, wherein the first shank is spaced apart from the second shank along the first longitudinal axis such that the first shank does not touch the second shank.

13. The driving tool of claim 12, wherein the first shank is formed from a first metal material, wherein the second shank is formed from the first metal material.

14. The driving tool of claim 12, the first shank extending along a second longitudinal axis that is colinear with the first longitudinal axis, and the second shank extending along a third longitudinal axis that is colinear with the first longitudinal axis.

15. The driving tool of claim 12, wherein the first shank defines a first length and the second shank defines a second length that is within 5% of the first length.

16. A driving tool comprising:
a handle; and
a shaft removably coupled to the handle, the shaft extending along a first longitudinal axis and including a first shank, a second shank, a joint, a first operative end extending from the first shank, a second operative end extending from the second shank, and a first coating circumferentially surrounding the first shank and a second coating circumferentially surrounding the second shank, wherein the first coating and second coating are formed from an electrically insulating material, the joint separating the first shank and the second shank, wherein at least a portion of the first shank is inserted in the handle when the second operative end is furthest from the handle and positioned to be used, and at least a portion of the second shank is inserted in the handle when the first operative end is furthest from the handle and positioned to be used.

17. The driving tool of claim 16, wherein the first coating does not cover the first operative end.

18. The driving tool of claim 16, the shaft comprising a shaft coating that includes the first coating and the second coating, and wherein the first coating is integrally molded with the second coating.

19. The driving tool of claim 18, the shaft coating defining a coating length, and the shaft defining a shaft length, wherein the coating length is at least 50% of the shaft length.

20. The driving tool of claim 18, the shaft coating defining a coating length, and the shaft defining a shaft length, wherein the coating length is at least 80% of the shaft length.
